(19) United States
(12) Patent Application Publication
(10) Pub. No.: US 2011/0232823 A1
(43) Pub. Date: Sep. 29, 2011

(54) METHOD FOR COATING THE SURFACE OF A THREE-DIMENTIONAL ARTICLE WITH A NATURAL WOOD LAYER

(76) Inventor: Zigmantas-Gedmundas Dubinskas, Plunge (LT)

(21) Appl. No.: 13/132,753

(22) PCT Filed: Nov. 26, 2009
(86) PCT No.: PCT/LT2009/000017

§ 371 Date: Jun. 3, 2011

(30) Foreign Application Priority Data
Dec. 4, 2008 (LT) 2008 098

(51) Int. Cl. B32B 38/04; B44C 3/12

(52) U.S. Cl. 156/63; 156/250; 156/196

(57) ABSTRACT

The invention relates to methods for producing a wood coating layer on a pre-shaped decorative surface of a three-dimensional article. In order to expand the range of articles coated with natural wood layer, the method includes the production of a three-dimensional wood coating matching the shape of the decorative surface of the article, the wood coating is being produced from a three-dimensional wood blank on which the surface has to be made matching an inverted copy of the decorative surface of the article, the wood blank is immovably attached to the decorative surface of the article and then, by removing an unnecessary wood layer from the wood blank, the wood coating layer of appropriate thickness is produced which exceeds a minimal permissible processing thickness applied for the kind of wood used.

The present invention relates to methods for producing of a wood coating layer on the pre-shaped decorative surface of a three-dimensional article.

Natural wood coatings due to their ornamental features are widely used for decorative coating of various three-dimensional articles. For example, EP 1392481 describes a method for the production of a three-dimensional, flexibly deformable flat element made of wood or a wood composite material for finishing layered, three-dimensional formed parts or for coating three-dimensional formed parts. The flat element obtained by using this method might be bent spatially in various directions. However only an article of proper configuration may be coated by using this method, that is, the article with no angular edges or with very small radii of curvature, because in junctions decompositions or ruptures of the coating as well as uneven misshaping may occur thus distorting a wood structure and texture.

During the course of the production of an article of appropriate form, a decorative wood coating may be misshaped spatially together with the base subject to coating. JP2001287721 describes a method of manufacturing a woody tray with a decorative wood coating of appropriate texture which comprises a dish-formed thermoplastic base material and sliced veneers which are laminated on a surface and a rear of the base material or on either the surface or the rear thereof, wherein when applying pressure to the tray the radius of curvature in bending lines is big and it makes no problems to produce not rupturing wood coating. However such method can not be applied when the coating should be produced on the already pre-shaped base with right angles.

EP0292367 discloses a method of making oblong decorative elements having a rigid profile made of metal, a visible face of which comprises a covering formed from a film of 0.5 to 2.0 mm in thickness made of natural wood and attached onto this face by means of an adhesive. By using this method it is possible to produce a high-quality decorative wood coating because the film can be bent along the wood fiber on the profile of simple configuration and a bending radius is sufficient in order the wood at the bending lines remain without ruptures.

The closest prior art disclosed in JP8072192 is a method for coating the surface of a three-dimensional article—a metal tube—with a natural wood layer wherein, firstly, the aluminum tube of predetermined shape looking like rectangle with rounded angles or round tube is manufactured and then a rigid wood coating matching the external surface of the base material is produced, which is being obtained from the wood slices by extruding two U-shaped or curved profiles, which are attached on the tube by means of adhesive and the opposite side edges of the profiles are adhered with each other. Before the process of extruding the wood slices are heated up, pressurized and softened in the presence of steam.

However the latter method only partially helps to expand variety of three-dimensional articles with decorative wood coating since it may be applied only for products of simple configuration, having no angular edges and with very small radii of curvature, because when applying pressure in affected places the coating may be damaged including ruptures and misshaping, thus distorting a wood structure and texture. Due to different radii the wood structure in bending lines should be thickened or rarefied and accordingly appearance of natural wood changes, and in the sections where two wooden profiles made from a veneer are paste together, a natural wood texture will not be matching and the junction will be clearly visible.

The main object of the invention is to provide a method for coating the surface of a three-dimensional article with a natural wood layer which would be able to coat a pre-shaped decorative surface of the article which, for example, is angular or has a very small radii of curvature, without distorting a wood structure and texture, and by applying this method to expand the range of articles coated with natural wood layer.

Another object of the invention also is to provide a method for coating the surface of a three-dimensional article with a natural wood layer enabling to produce a different thickness of the coating in different sections of the article.

The third object of the invention is to reduce quality requirements for the decorative surface of a three-dimensional article subject to coating.

According to the present invention there is provided a method for coating the surface of a three-dimensional article with a natural wood layer including production of a three-dimensional coating matching the shape of a decorative surface of the article, wherein the three-dimensional coating is produced from a three-dimensional wood blank matching an inverted copy of the decorative surface of the article and then, by removing an unnecessary wood layer from the wood blank, the wood layer of appropriate thickness is produced which exceeds a minimal processing thickness applied for kind of wood used.

Minimal rigidity of the article made from metal, glass, plastic or other materials and subject to coating by applying the present invention should be such to prevent misshaping of the article when processing attached a solid wood blank or a wood blank made from glued parts, because when performing processing it is practically impossible for a slim (0.3-1.5 mm in thickness) wood layer of complicated configuration to withstand a three-dimensional shaping without affecting the surface rigidity of the article subject to coating due to the impact of processing tools and direction of the wood layers, the wood layer not pasted with the surface of the product subject to coating would simply fall into pieces. Minimal thickness of the wood layer of the coating should be selected depending on physical, biological and mechanical features of wood, such as density, softness, rigidity, porosity, fissility, etc.

If necessary or for simplicity to produce the coating, the method for coating a surface of a three-dimensional article with a natural wood layer enables to make a different thickness of the wood layer on the decorative surface of the article and facilitates the process of coating production. Moreover, the thickness of the wood layer also depends on the shape of the article, on application and exploitation conditions of the article as well as on requirements to processing the coated surface (staining, polishing, waxing, engraving, marking, etc.). Usually thickness of the produced wood layer ranges from 0.3 to 3.0 mm.

When expanding glue is used to paste the wood blank with the decorative surface of the three-dimensional article, quality requirements for the decorative surface subject to coating might be reduced because as the glue expands it is being distributed in different thickness and fills in occurred gaps, thus when the glue hardens and the processed surface becomes more rigid it is much easier to remove an improper wood layer from the wood blank.

The presents invention enables industrial use of the method for coating with a natural wood layer the surfaces of three-dimensional articles of complicated shape, made from metal, plastic, glass and from other materials which can not be coated by involving other known methods and thus expands the variety of items with wood coating in order to satisfy various needs of the customers. The invention may be applied in the field of cosmetics, perfumery, furniture, electrical engineering, for fittings of doors and windows, for items of vehicles control and for internal decoration as well as to hide junctures of design elements by using covers, caps, etc. Moreover this invention enables producing of three-dimensional articles, the surface of which or part thereof will be coated by applying said method, by using cheaper raw materials. For example, brass may be replaced with aluminum or other metal; glass may be replaced with aluminum or plastic, stainless steel may be replaced with plate steel, etc.

Embodiments of the present invention are described, by way of example, with reference to the accompanying drawings.

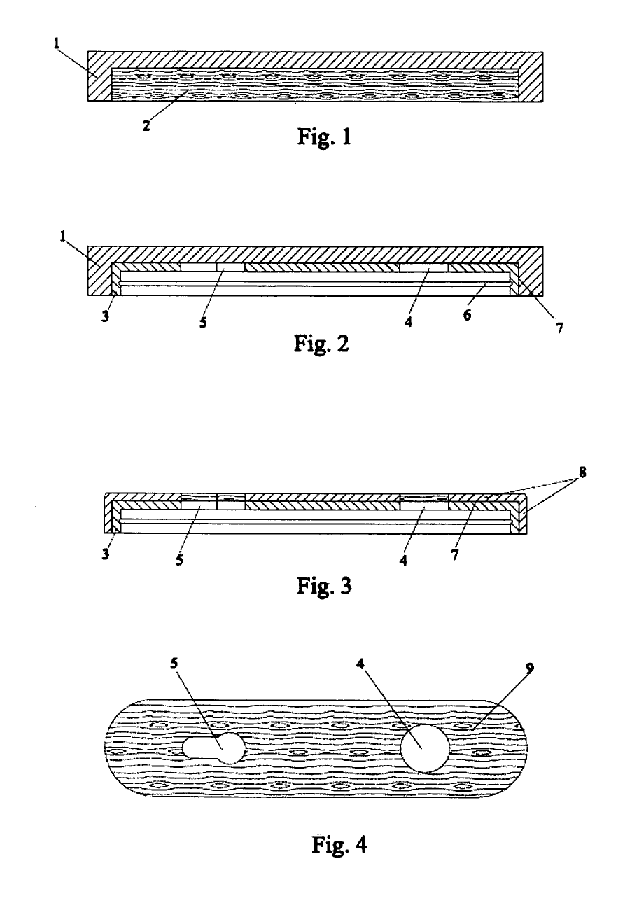

FIG. 1 shows a cross-section of a wood blank to be used for the production of a natural wood layer for coating the decorative surface of door handle and fixing plate cap.

FIG. 2 shows a cross-section of the wood blank according to FIG. 1 with a fixing plate cap embedded.

FIG. 3 shows a cross-section of the cap according to FIG. 2 with completely processed wood layer.

FIG. 4 shows an overhead view of the cap according to FIG. 3 with completely processed wood layer.

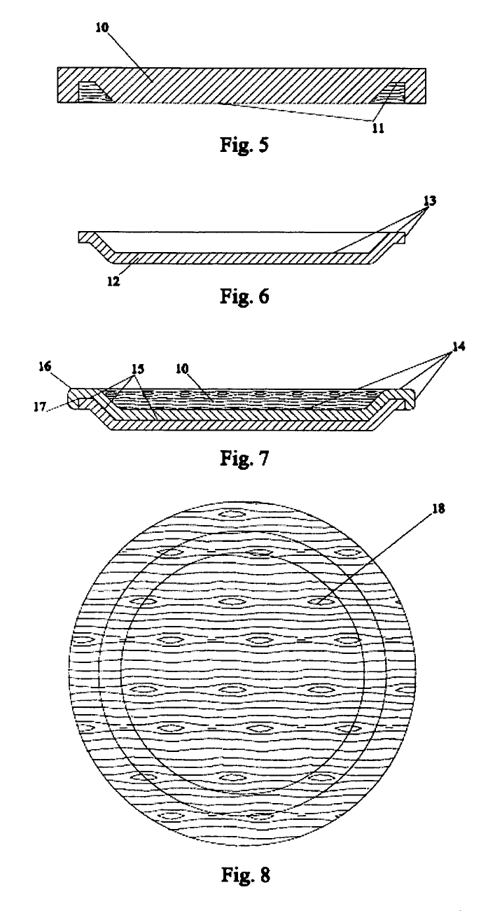

FIG. 5 shows a cross-section of a wood blank to be used for a natural wood layer on the internal side of a decorative plate.

FIG. 6 shows a cross-section of the decorative plate being in process of coating.

FIG. 7 shows the decorative plate coated with the wood layer according to FIG. 6 after complete processing

FIG. 8 shows an overhead view of the decorative plate coated with the wood layer according to FIG. 7.

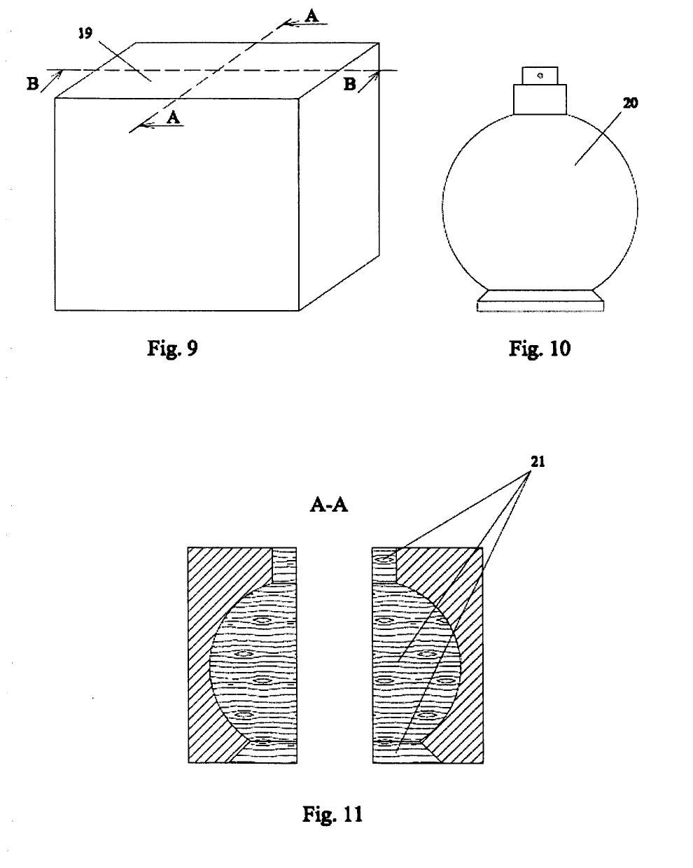

FIG. 9 shows a solid three-dimensional wood blank in axonometry intended to produce a natural wood layer on the decorative surface of a perfume vial.

FIG. 10 shows an overhead view of the perfume vial, which needs to be coated with a natural wood layer produced from the wood blank according to FIG. 9.

FIG. 11 shows a cross-section of a shredded wood blank according to FIG. 9 with shaped internal surface to seat the perfume vial according to FIG. 10

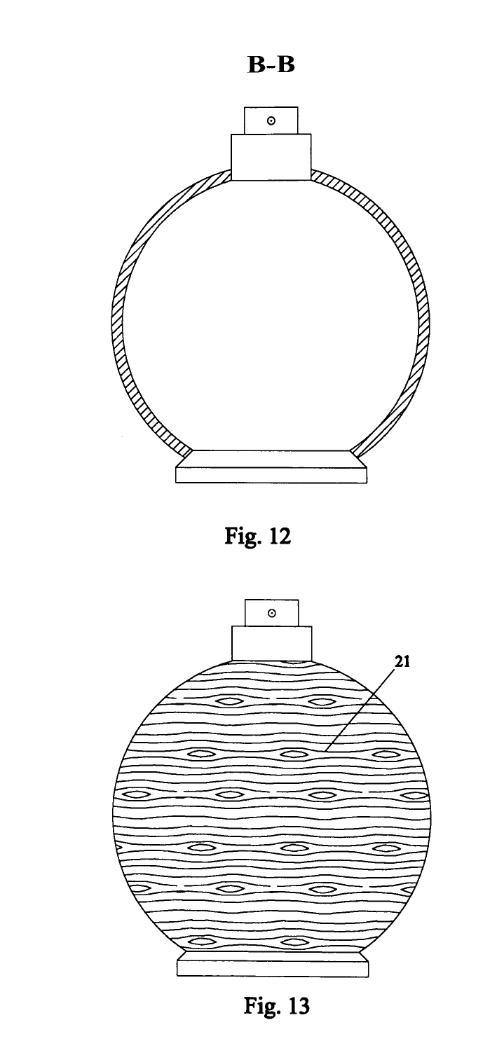

FIG. 12 shows a B-B cross-section of a wooden part of the perfume vial coated with the wood layer according to FIG. 10 after processing.

FIG. 13 shows a front view of the perfume vial coated with the wood layer according to FIG. 10.

### EXAMPLE 1

In a way of turning, milling, drilling or by using other known wood processing means, a blank 1 (FIG. 1) of natural wood (e.g. oak, beech, mahogany, nut, peer-tree, apple-tree or other wood strain suitable for decorative finishing) is provided with a cavity 2 in order to seat there a cap 3 of door handle and of lock cylinder fixing plate (FIG. 2) including a gap 4 to seat a handle itself and a gap 5 to seat a cylinder lock as well as a groove 6 to fix the cap 3 on the plate (not available in the drawing). The surface of the cavity 2 (FIG. 1) is precise copy of external surface of the cap 3 including overlap for glue. Then the external surface 7 of the cap 3 by applying glue should be pasted with the surface of the cavity 2 of the wood blank 1 (FIG. 2) and a rigid construction involving a combination of wood blank 1 and the cap 3 is produced. After that in a way of turning, milling or by using other known wood processing means, unnecessary wood layer should be removed from said combination and coating 8 with 0.3-3.0 mm in thickness is produced. FIG. 4 shows texture lines 9 of the surface of door handle and of the cap of lock cylinder fixing plate.

### EXAMPLE 2

By using proper wood processing means, the surface 11 should be shaped on the wood blank 10 (FIG. 5), which is the inverted copy of internal surface of a plate 12 (FIG. 6) subject to coating with a natural wood layer. Then the rigid plate 12 (FIG. 6) should be put on the surface 11, the surface 13 of the plate 12 should be glued up to the wood blank 10 (FIG. 5). After that by using turning machine unnecessary wood layer should be removed up to the line 14 from a produced combination of wood and plate and the coating 15, for instance, of 0.5-2.0 mm in thickness is produced (FIG. 7), the external edge 16 of which has very small radius of curvature and the internal edge 17 is vertical. FIG. 8 shows an overhead view of the place coated with a wood layer where wood texture lines 18 are visible on the decorative coating.

### EXAMPLE 3

The FIG. 9 shows a solid wood blank 19 to seat a perfume vial 20 (FIG. 10) for which in order to provide a desirable design, a slim wood layer coating is to be applied on its ball shape (spheral) part. In order to do this, the blank 19 (FIG. 9) along the section line B-B is divided into two parts, in which in a way of turning, milling or by involving other means grooves 21 (FIG. 11) are made, shown in the section A-A, which are copies of the vial surface subject to coating 20 (FIG. 10) including overlap for glue layer. After the glue covers the grooves, the vial is seated in and blanks are pasted with each other. When in a way of turning unnecessary wood layer should be removed and natural wood coating of 0.5-3.0 mm in thickness is shaped on the surface of the vial 20 (FIG. 10). FIG. 12 shows cross-section B-B of a wooden part after processing. In FIG. 13 a front view of the vial coated with a wood layer is shown, where 21 shows texture lines.

Furthermore, the invention is not restricted to the embodiments which have been described by way of examples, however they remain within the scope of the present invention. More examples may be provided describing the process when in order to produce the decorative coating with a concave surface, a camber is produced in the wood blank, and when the matter refers to coatings with a convex surface—a concave is produced. When the wood blank is designed to seat the product of tetrahedron, pyramid, cone or other shape with concave and convex surfaces and if it is impossible to do this the blank is divided into two or more parts in order to seat a new article into these parts. After that in way of milling, drilling and turning or by applying other known wood processing means in each part of the divided blank, a groove is made, similar to that part of surface of the article, which should be covered by the wood blank including an overlap for glue layer. Then the article is seated into the wood blanks processed from one side and glued up, then the blanks are glued up or pasted with each other otherwise. When a rigid combination of the article and wood is produced, unnecessary wood layer should be removed by involving proper wood processing means, thus coating of 0.3-3.0 mm thickness is produced.

It is no doubt that when much exclusiveness (decorative expressions, colors, etc.) should be provided for the surface, wood blanks of different kinds of wood should be pasted together prior to producing an inverted copy of surface of the article subject to coating. The coating with different textures may be produced from different kinds of wood.

1.-7. (canceled)

8. The method for producing a solid wood layer around a three-dimensional article including adhesion of the wood to the surface of the article or any of its parts and subsequent processing of the wood layer, characterized in that the said wood layer attached to the surface of the article is made of a solid three-dimensional wood block by forming a precise convex or concave (as the case may be) inverted copy of the surface of the article to be coated plus a margin for any appropriate binding material (e.g. glue, varnish, etc.), fitting and attaching the article in the concavity or on the convexity, removing the unnecessary wood by any known woodworking method by keeping the article rather than wood block fixed immovably during the removal of unnecessary wood and obtaining in this way a solid wood layer of predetermined thickness around the article.

9. The method for producing a solid wood layer around a three-dimensional article according to claim 8, characterized in that the minimum rigidity of the material of the article and the article itself must be such as to prevent deformation of the article with the affixed wood layer during and after the removal of the unnecessary wood from the wood blank.

10. The method for producing a solid wood layer around a three-dimensional article according to claim 8, characterized in that the thickness of the wood layer on the surface of the article may be different.

11. The method for producing a solid wood layer around a three-dimensional article according to claim 8, characterized in that the thickness of the wood layer on the surface of the article may be in the range of 0.3-3 mm.

12. The method for producing a solid wood layer around a three-dimensional article according to claim 8, characterized in that the said wood layer is produced from a solid wood block split into two or more parts by any means before forming a precise convex or concave inverted copy of the surface of the appropriate part of the article to be coated, which are glued to the surface of the appropriate part of the article and then glued together.

13. The method for producing a solid wood layer around a three-dimensional article according to claim 8, characterized in that a unique decorative layer is produced by gluing together wood pieces of different kind and colour into a solid block and by forming a precise convex or concave inverted copy of the surface of the article.

14. The method for producing a solid wood layer around a three-dimensional article according to claim 8, characterized in that the wood block is attached to the surface of the article with the help of an expanding material.
